(19) United States
(12) Patent Application Publication
(10) Pub. No.: US 2009/0115285 A1
(43) Pub. Date: May 7, 2009

(54) LIQUID-GAP ELECTROSTATIC HYDRAULIC MICRO ACTUATORS

(76) Inventors: Khalil Najafi, Ann Arbor, MI (US); Hanseup Kim, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 12/247,574

(22) Filed: Oct. 8, 2008

Related U.S. Application Data
(60) Provisional application No. 60/997,768, filed on Oct. 8, 2007.

(51) Int. Cl. H02N 11/00; F16K 31/02; H04R 17/00

(52) U.S. Cl. 310/300; 251/61.1; 29/25.35

(57) ABSTRACT

A liquid-gap electrostatic hydraulic micro actuator is provided that produces higher displacement (in and out of plane) and larger force than typical electrostatic actuators by utilizing a non-conducting liquid as its dielectric material. This new class of actuators utilizes the liquid dielectric for hydraulic amplification and force transfer. The liquid electrostatic actuator consists of two chambers each forming a parallel-plate capacitor, filled with a non-conducting incompressible liquid. One chamber is compressed by pulling down a flexible membrane using electrostatic actuation, thus forcing the liquid under it to transfer into the other chamber. Such movement causes the other chamber's membrane to expand out of plane.

### CROSS-REFERENCE TO RELATED APPLICATIONS

This application claims the benefit of U.S. Provisional Application No. 60/997,768, filed on Oct. 8, 2007. The entire disclosure of the above application is incorporated herein by reference.

### GOVERNMENT RIGHTS

This invention was made with government support under EEC-9986866 awarded by the National Science Foundation. The government has certain rights in the invention.

### FIELD

The present disclosure relates to electrostatic micro actuators and, more particularly, to liquid-gap electrostatic hydraulic micro actuators.

### BACKGROUND AND SUMMARY

This section provides background information related to the present disclosure which is not necessarily prior art. Additionally, this section provides a general summary of the disclosure, and is not a comprehensive disclosure of its full scope or all of its features.

Electrostatic micro actuators have been widely used for numerous applications, such as gas micropumps, micro valves, and optical switching, due to their simple structure, high-speed operation, and compatibility with thin-film fabrication. However, typical air-gap electrostatic actuators produce limited force and deflection in the micro domain because the air gap distance, which determines the maximum deflection, cannot be large enough to obtain sufficient mechanical force. Hydraulic actuators, on the other hand, have been used in numerous macro-scale applications and utilize incompressible liquids for hydraulic amplification and force transfer. Although electrostatic actuation in aqueous environments has been investigated, no micro devices that utilize non-conducting liquid for electrostatic actuation and hydraulic force transfer have been reported.

Additionally, to realize a high-pressure micro valve, a pressure-balance scheme and hydraulic amplification have been previously introduced. However, these attempts suffered from a number of disadvantages, such as their inability to be used in wide range of flow conditions or their focus on the use of hydraulic systems where the hydraulic liquid is used only for force amplification.

By way of background, electrostatic micro actuators may be formed by two parallel plates separated by an air gap. The plates may be attracted to each other (referred to as deflection in plane) by applying an electric potential across the plates. Coulomb's Law may govern the attractive force:

$$F = k \frac{{q}_{1} {q}_{2}}{{r}^{2}} ,$$

where k is a constant inversely proportional to the permittivity ∈ of the air gap, r is the distance between the plates, and q₁ and q₂ are the charges on the plates induced by the electric potential. Causing the parallel plates to separate from each other (referred to as deflection out of plane) is more difficult. A spring or some other sort of return mechanism may be used.

Typical air-gap electrostatic actuators produce limited force and deflection in the micro domain because mechanical force decreases with the square of the air gap distance r. The air gap distance r determines the maximum deflection, which cannot therefore be too large, or sufficient mechanical force will not be obtained. In addition, the permittivity ∈ of air is relatively low, at approximately 1.

Micro actuation in liquidic environment has been occasionally studied in the past. For example, diffusion and swelling of hydrogel has been used to deflect polydimethylsiloxane (PDMS) diaphragms. The deflection of a membrane has been amplified using area-ratioed hydraulic systems in a piezoelectric micro piston structure. High volumetric expansion of electrothermally heated paraffin has been used to deform a sealed diaphragm.

According to the principles of the present teachings, hydraulic liquid is used both as a high permittivity material as well as an amplification liquid to build a high-force micro actuator, which can be a building block for high-force and large-deflection applications, such as, a high-pressure three-way micro valve.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional view of a liquid-gap electrostatic micro actuator according to the principles of the present teachings;

FIG. 2A is a cross-sectional view of the liquid-gap electrostatic micro actuator being actuated to cause an expansion in a first chamber;

FIG. 2B is a cross-sectional view of the liquid-gap electrostatic micro actuator being actuated to cause an expansion in a second chamber;

FIGS. 3A-3E is a series of manufacturing steps for fabricating the liquid-gap electrostatic micro actuator;

FIG. 4A is a graph illustrating a measured capacitance variation during bi-stable electrostatic actuation together with photographs of the liquid-gap electrostatic micro actuator during actuation;

FIG. 4B is a graph illustrating the measured transient capacitance change using a LabView and HP4208 LCR meter;

FIG. 4C is a graph illustrating the measured deflection and surface profile of a 2×2 mm² membrane during hydraulic inflation and electrostatic compression periods, respectively, using a Dektak surface profiler;

FIG. 5 is a cross-sectional view of a micro valve employing the liquid-gap electrostatic micro actuator to selectively close outlets of the micro valve according to the principles of the present teachings;

FIG. 6A is a cross-sectional view of the liquid-gap electrostatic micro actuator valve being actuated to cause an expansion in a first chamber to close a first outlet;

FIG. 6B is a cross-sectional view of the liquid-gap electrostatic micro actuator valve being actuated to cause an expansion in a second chamber to close a second outlet;

FIGS. 7A-3E is a series of manufacturing steps for fabricating the liquid-gap electrostatic micro actuator valve;

FIG. 8A is a photograph of the liquid-gap electrostatic micro actuator valve;

FIG. 8B is a graph illustrating flow rate vs. input pressures when one output is opened;

FIG. 8C is a graph illustrating flow rate vs. input voltage representative of valve closure voltages for both AC and DC signals under different backpressures;

FIG. 8D is a graph illustrating valve-closure voltages vs. input pressure for the liquid-gap electrostatic micro actuator valve;

FIG. 9 is a graphical depiction of hydraulic amplification of the deflection distance and the force transfer in an exemplary electrostatic actuator;

FIG. 10 is a schematic view of a liquid-gap electrostatic micro actuator having a plurality of chambers according to some embodiments of the present teachings;

FIG. 11 is a schematic view of a liquid-gap electrostatic micro actuator having a plurality of chambers according to some embodiments of the present teachings; and

FIG. 12 is a schematic view of a liquid-gap electrostatic micro actuator having a plurality of chambers according to some embodiments of the present teachings.

Corresponding reference numerals indicate corresponding parts throughout the several views of the drawings.

### DETAILED DESCRIPTION

Example embodiments will now be described more fully with reference to the accompanying drawings. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

According to the principles of the present teachings, a capacitive electrostatic actuator is provided that produces higher displacement (in and out of plane) and larger force than typical electrostatic actuators by utilizing a non-conducting liquid as its dielectric material. This new class of actuators utilizes the liquid dielectric for hydraulic amplification and force transfer. That is, the actuator according to the present teachings employs a movable liquid disposed in micro chambers, wherein the movable liquid is both a high dielectric constant medium for generating high force in response to electrostatic principles and a generally-incompressible material for generating large deflection in response to hydraulic principles.

Generally, the liquid electrostatic actuator consists of two chambers, each forming a parallel-plate capacitor, filled with a non-conducting incompressible liquid. One chamber is compressed by pulling down a flexible membrane using electrostatic actuation, thus forcing the liquid under it to transfer into the other chamber. Such movement causes the other chamber's membrane to expand out of plane. Fabricated liquid-gap actuators with de-ionized (DI) water as the working liquid according to the principles of the present teachings have produced out-of-plane deflection of 36.7 and 16 μm from 2×2 and 1×1 mm² chambers, respectively, using 320V actuation voltage.

Additionally, according to the principles of the present teachings, an electrostatically-operated micro-hydraulic three-way micro valve is provided, which is capable of operating under high pressure (>50 kPa) with high gas conductance (2.03 sccm/kPa). The micro valve is operated by an electrostatically-generated force, which is then hydraulically amplified using DI water as the hydraulic liquid and as a motional valve shutter. The hydraulic micro valve provides (1) high pressure operation due to high electrostatic force provided by the high dielectric constant of DI water (∈_{water}=80), (2) high gas conductance due to large liquidic passages that can be closed/opened using the high deflection actuator, and (3) simple electrical control. It has high gas conductance of 20.3 sccm at 10 kPa, an electrostatic valve closure against backpressure of >50 kPa for a leakage of <10 μL/min, an active area of 11.4×9.1 mm², and a valve housing (dead) volume of 8.4×6.1×0.03 mm³.

### Liquid-Gap Electrostatic Actuator

With particular reference to FIG. 1, a liquid-gap electrostatic actuator 10 is provided having a flexible polymer membrane 12 that is enclosed to form a first section or chamber 14 and a second section or chamber 16. A first pair of electrodes 18 are positioned on opposing sides of first chamber 14 of flexible polymer membrane 12 in a clamping position—in other words, the first pair of electrodes 18, as illustrated, are positioned in opposing relation to exert a clamping pressure therebetween upon the flexible polymer membrane 12.

A power source 20 is electrically coupled to the first pair of electrodes 18 to provide an electrical charge to the first pair of electrodes 18 to cause an attractive force therebetween (i.e. electrostatic actuation). In some embodiments, a control system 22 is disposed within an electrical circuit 24 formed with the first pair of electrodes 18 and the power source 20. Control system 22 can be a controller operable to selectively apply the electrical charge from power source 20 to the first pair of electrodes 18. Control system 22 can be manually actuated or automated as desired. The power source 20 (or a separate power source) is further electrically coupled to a second pair of electrodes 26 to provide an electrical charge to the second pair of electrodes 26 to cause an attractive force therebetween. In some embodiments, the control system 22 (or a separate control system) is disposed within an electrical circuit 28 formed with the second pair of electrodes 26 and the power source 20.

In some embodiments, a liquid channel or volume 30 is positioned between first chamber 14 and second chamber 16 to permit liquid flow therebetween. It should be appreciated that liquid channel 30 can be formed as a liquid pathway having a differing size, shape, material, or other property than the first chamber 14 and/or second chamber 16. Alternatively, first chamber 14 and second chamber 16 can be formed such that a liquid channel 30 is not specifically defined in that there is little to no space between first chamber 14 and second chamber 16, such that a channel interface is generally indistinguishable and first chamber 14 and second chamber 16 define a single continuous volume. In other words, flexible polymer member 12 could define a single volume that is shaped such that it is unable to be parsed in to more than simply a first chamber and a second chamber that are each separately compressible.

Still referring to FIG. 1, in some embodiments, liquid-gap electrostatic actuator 10 can be disposed on or comprise a substrate 34. Substrate 34 can be made of any material capable of providing a reliable support structure. Substrate 34 can be, in some embodiments, made of glass. It should be appreciated, however, that substrate 34 is optional.

Liquid-gap electrostatic actuator 10 further comprises a liquid 32 disposed within flexible polymer member 12, such as within first chamber 14, second chamber 16, and optional liquid channel 30. In some embodiments, liquid 32 is water, deionized water, a non-conducting incompressible liquid, or the like.

Properties of the liquid that may be used in selection may include viscosity and how inert the liquid is with respect to the membrane and/or other features that the liquid may contact during fabrication. The liquid may be added to the actuator during fabrication in a non-fluid state. For instance, the liquid could be added in solid form at temperatures lower than the operating temperature of the actuator, with the liquid assuming its fluid state at the operating temperature.

The liquid may be in a solid state at room temperature, and may be heated in order to employ the actuator. When the heat is removed, the liquid may resume the solid state, thus maintaining the actuator at its current position. Heating may be accomplished by any suitable means, including resistive micro heaters that are well known in the art.

In some embodiments, the liquid may even be conducting. Electrostatic actuation may be possible in conductive liquids if the actuation speed exceeds that of the molecules in given liquids (which is typically greater than tens of kHz). See, e.g., Thomas L. Sounart, Terry A. Michalske, and Kevin R. Zavadil, Frequency-Dependent Electrostatic Acuation in Microliquidic MEMS, Journal of Microelectromechanical Systems, Vol. 14, No. 1, February 2005; and Vikram Mukundan and Beth L. Pruitt, Experimental Characterization of Frequency Dependent Electrostatic Actuator for Aqueous Media, presented at Solid State Sensors, Actuators, and Microsystems Workshop, Hilton Head, S.C., 2006, the disclosures of which are incorporated herein by reference in their entirety.

The existence of liquid 32 within first chamber 14, second chamber 16, and optional liquid channel 30 serves at least two functions: 1) the large liquid dielectric constant produces a larger electrostatic force than is available in air-gap electrostatic actuators; and 2) the liquid acts as the hydraulic amplification liquid that transfers the large electrostatic force from one chamber to the other. Liquid-gap electrostatic actuator 10 can achieve larger electrostatic force using a larger relative permittivity of water (∈=80) than that of air (∈=1). The high electrostatic force is transferred through the confined liquid 32 to the opposing chamber. Liquid-gap electrostatic actuator 10 achieves a large out-of-plane distance in the opposing chamber, since the maximum distance is determined by the transferred liquid volume instead of the gap between electrodes. Liquid-gap electrostatic actuator 10 also produces higher force by differentiating each chamber area. The resultant force from each chamber is determined by the area ratio between the two chambers 14, 16, since the pressure in liquid is uniform and thus the actuation force is proportional to the areas of the chambers 14, 16. It should be appreciated that a “liquid”, as used herein, does not constitute a gas.

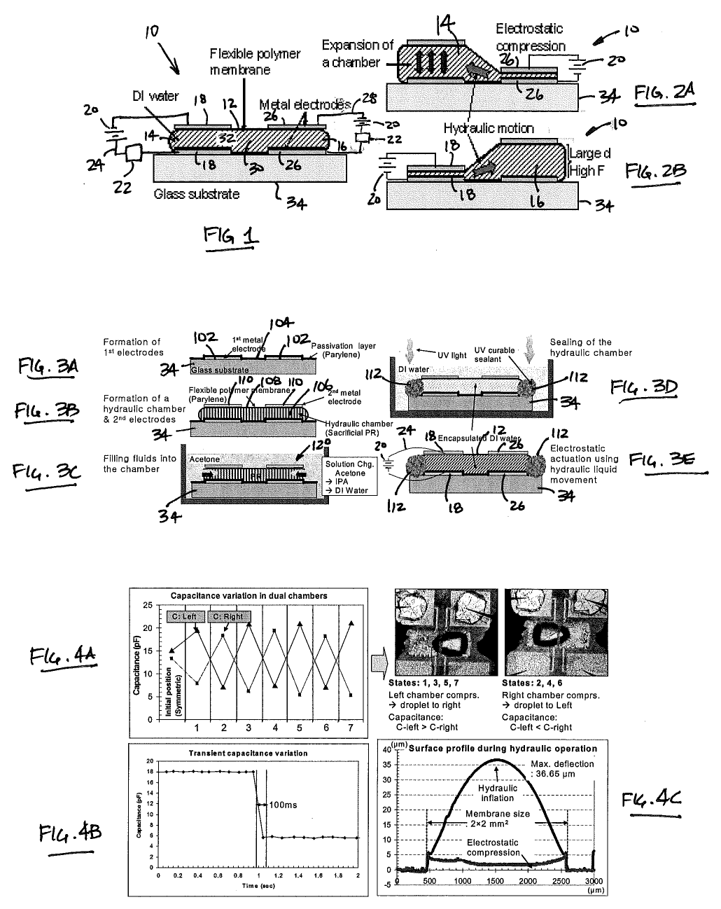

In operation, control system 22 is actuated to selectively permit electrical power from power source 20 to flow through circuit 24, 28 to a corresponding pair of opposing electrodes 18, 26. Such electrical power causes the pair of electrodes to develop an electrostatic attraction urging the opposing electrodes toward each other, as illustrated in FIG. 2A. This collapsing movement of the opposing electrodes exerts a clamping force upon the corresponding chamber 14, 16 of flexible polymer member 12, thereby forcing the liquid 32 into the other chamber 16, 14 causing expansion thereof. Control system 22 can then be actuated to selectively permit electrical power from power source 20 to flow through the other circuit 28, 24 to the other corresponding pair of opposing electrodes 26, 18. Such electrical power causes the pair of electrodes to similarly develop an electrostatic attraction urging the opposing electrodes toward each other, as illustrated in FIG. 2B. This collapsing movement of the opposing electrodes exerts a clamping force upon the corresponding chamber 16, 14 of flexible polymer member 12, thereby forcing the liquid 32 back into the chamber 14, 16 causing expansion thereof. The work associated with the expansion (or contraction) of the chambers of flexible polymer member 12 can be harnessed for use in valves, actuators, and the like.

In some embodiments, liquid-gap electrostatic actuator 10 has been fabricated on a glass substrate 34 using surface micromachining and liquid encapsulation as illustrated in FIGS. 3A-3E. As illustrated in FIG. 3A, the first actuation electrode 18 is patterned on a glass substrate 34 by evaporating Cr/Au (300/4000 Å) 102, and then insulated with a polyxylylene polymer, such as Parylene (0.5 μm) 104. Next, as illustrated in FIG. 3B, a sacrificial photoresist (6.5 μm) 106 is patterned to define the actuator chambers 14, 16. A second polyxylylene polymer (3.5 μm) layer 108, such as Parylene, is deposited to form a flexible moving membrane that encapsulates the chambers 14, 16. Another metal layer 110 is then deposited and patterned to form the opposing electrode on top of the flexible membrane.

As illustrated in FIG. 3C, the entire assembly 120 is then immersed into a series of liquids, such as Acetone, IPA, and DI water to dissolve the sacrificial layer 106, release the actuation chambers 14, 16, and fill the chambers 14, 16 with DI-water. For example only, the liquid may be introduced by any other technique, such as via diffusion or by condensing pressurized vapors. Finally, as illustrated in FIG. 3D, the chamber is sealed while immersed in the liquid (i.e. water) using UV curable sealant 112, thus preventing trapping of air bubbles inside the chamber and results in the final assembly illustrated in FIG. 3E. Air bubbles may be minimized, to maximize the hydraulic efficiency of the system. The liquid may be introduced while a vacuum is pulled across the membrane, to prevent air bubbles from forming.

It should also be appreciated that sealing the volume of flexible polymer member 12 (i.e. chambers 14, 16) may be performed in any suitable manner, such as by manually applying sealant, which can then be cured in any suitable process, such as exposure to UV light. Sealant that is permeable by the liquid may be applied while the wafer is in a vacuum, and the liquid may be introduced once the sealant is in position. Once the liquid diffuses into the chamber, the sealant may be cured to retain the liquid. In addition, liquid may be added by opening a hole in the substrate, pulling a vacuum, and introducing the liquid. The substrate can then be resealed. This may be performed across multiple actuators simultaneously.

The sealing process may be performed in the aqueous environments where the original sacrificial layer (photoresist) was dissolved by an appropriate liquid (acetone) and then the liquid is replaced by diffusion with subsequent other liquids. The replacement process can be repeated until the desired purity of the following liquid is achieved. Actual sealing may be achieved by plugging the inlet and the outlet for liquid filling with a water-proof epoxy. The method can be also achieved at the wafer level by different wafer-bonding techniques.

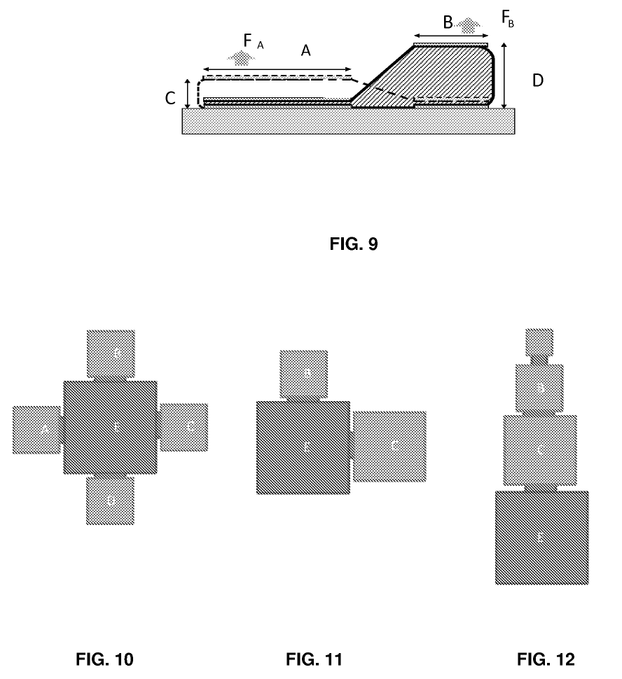

With particular reference to FIG. 9, a graphical depiction of hydraulic amplification of the deflection distance and the force transfer in an exemplary electrostatic actuator is illustrated. The higher force possible in a hydraulic actuator is due to Pascal's law, which governs hydraulic systems: “pressure exerted on a confined liquid is transmitted undiminished in all directions and acts with equal force on all equal areas.” See James A. Sullivan, Fluid Power Theory and Applications, Prentice Hall 1998, pp. 15-90.

$$Pressure = \frac{{Force}_{1}}{{Area}_{1}} = \frac{{Force}_{2}}{{Area}_{2}}$$

From this equation above, higher actuation force can be achieved by changing the area of contact. The resultant force from each chamber is determined by the area ratio between the two chambers, since the pressure in liquid is uniform and thus the actuation force is proportional to the areas of the chambers 14, 16. By way of illustration, assume that the membranes shown in FIG. 9 are square, though in actuality they could be of any shape. Deflection amplification is then determined by:

$$\frac{C}{D} = \frac{{B}^{2}}{{A}^{2}} ,$$

and force amplification is determined by:

$$\frac{{F}_{A}}{{F}_{B}} = \frac{{A}^{2}}{{B}^{2}} .$$

With reference to FIGS. 10, 11, and 12, a plurality of exemplary actuators is provided each having than two chambers. This may allow for greater amplification, more accurate amplification, binary control, and simultaneous actuation. For example, as illustrated in FIG. 10, the actuator comprises chambers A, B, C, and D connected to larger chamber E. Chambers A, B, C, and D may individually be fully compressed by applying a potential across them. This may allow for control of 1×, 2×, 3×, or 4× movement or force on chamber E. Electrostatic latching may be used to keep chambers A, B, C, or D compressed, thereby decreasing power consumption.

Alternatively, chamber E can be compressed, causing expansion of each of chambers A, B, C, and D. To increase the deflection of other chambers, at least some of the chambers A, B, C, and D may be fixed in a compressed state. With reference to FIG. 11, differentially sized chambers B and C may be used to actuate chamber E to two different deflection distances.

Moreover, the arrangement illustrated in FIG. 12 may allow for 3-bit binary control of the displacement of chamber E. If the volumes of chambers A, B, and C are in the ratio 1:2:4, the force or deflection of chamber E can be determined by the binary value b₂b₁b₀, where b₀ is used to control chamber A, b₁ is used to control chamber B, and b₂ is used to control chamber C. Chambers may be controlled by direct current (DC), alternating current (AC), or any other suitable method. Hydraulic amplification can be used to amplify or modulate the geometry variations of each chamber in a controlled manner. Certain chambers may be controlled electrostatically to control the effective hydraulic actuation of other chambers, varying the effective number of chambers, configurations, and area ratios. Also, in addition to providing higher in plane deflection/force by having a higher permittivity, the liquid allows hydraulic motion that can increase out of plane deflection and/or force.

As illustrated in FIGS. 4A-4C, the hydraulic movement of liquid-gap electrostatic actuator 10 shows repeatable capacitance variations as one chamber collapses and the other expands (FIG. 4A). At each cycle, one of the two chambers 14, 16 is compressed, and the corresponding capacitance changes as the liquid moves in or out of the chamber. As illustrated in FIG. 4B, the capacitance variation of one chamber as it is electrostatically compressed, indicates faster than 100 ms response time (limited only by the measurement system). Still further, with reference to FIG. 4C, the measured deflection and compression of a 2×2 mm² membrane by hydraulic amplification and electrostatic actuation can be seen, respectively. From this graph, the measured out-of-plane deflection was 36.7 μm at an operation voltage of 320V.

### Micro Valve Design

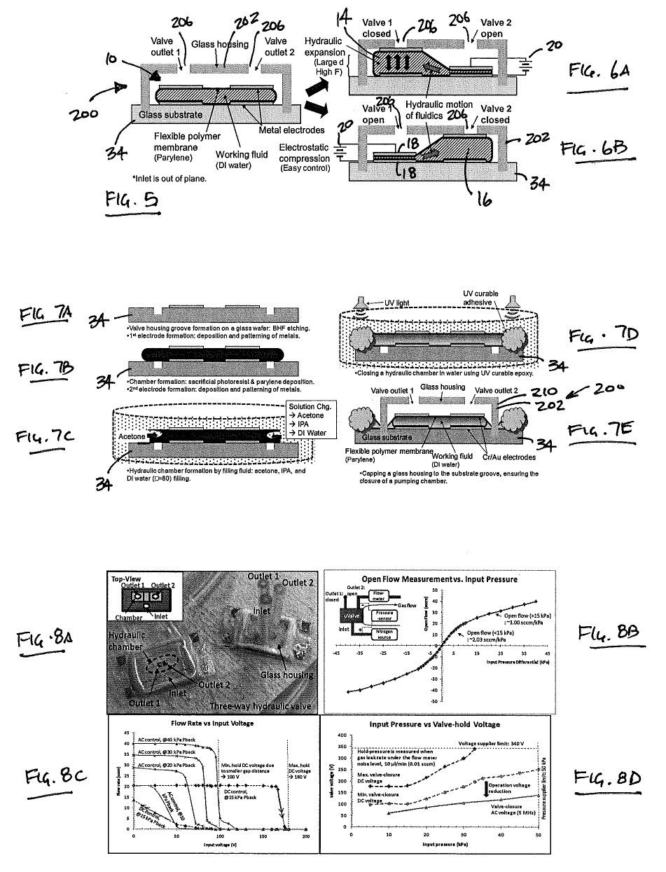

In some embodiments, as illustrated in FIGS. 5, 6A, and 6B, a micro valve 200 can be provided employing liquid-gap electrostatic actuator 10. However, it should be appreciated that the micro valve 200 is only one of a plurality of applications in which liquid-gap electrostatic actuator 10 can be used. Therefore, the following discussion should not be interpreted as embodying the only use for liquid-gap electrostatic actuator 10.

In some embodiments, micro valve 200 can comprise a valve housing 202 that contains an inlet 204 and two outlet ports 206, and liquid-gap electrostatic actuator 10. The outlet ports 206 are selectively opened and closed by the underlying hydraulic chambers 14, 16 of liquid-gap electrostatic actuator 10. That is, the hydraulic chamber is controlled by two pairs of electrostatic electrodes. When one chamber is electrostatically compressed, the hydraulic liquid moves into the second chamber expanding it and closing the corresponding outlet port 206 in valve housing 202 of micro valve 200 (FIGS. 6A and 6B). When the second chamber is compressed, the liquid moves back to the first chamber opening the outlet above the second chamber and simultaneously closing the outlet above the first chamber. This valve is easily controlled using electrostatic actuation and amplifies both the force and deflection through hydraulic liquid motions.

As illustrated in FIGS. 7A-7E, fabrication of micro valve 200 comprises lithography, etching, liquid encapsulation, and valve housing attachment. Similar to the process described above, a pair of Cr/Au actuation electrodes (2×2 mm²) is patterned on a glass substrate 34, and then insulated with polyxylylene polymer, such as Parylene (0.5 μm). Next, a sacrificial photoresist (6.5 μm) is patterned to define the actuator chambers 14, 16. A second polyxylylene polymer layer, such as Parylene, (3.5 μm), and metal layer are deposited and patterned to form the second electrode on top of the chambers 14, 16. The whole assembly is immersed into a series of liquids (Acetone, IPA, and DI water) to dissolve the sacrificial layer and form the actuation chambers 14, 16, and filled finally with DI water. The chamber is sealed in water using UV curable adhesive. However, as a final step separate from the previously described process, a glass housing 202 is attached, completely sealing liquid-filled chambers 14, 16. In some embodiments, a top section 210 of housing 202 is inserted over glass substrate 34 and received in a recess 212 of substrate 34. In some embodiments, the membrane can be pinched or otherwise sealed by the joining of top section 210 to substrate 34 as illustrated.

In some embodiments, as illustrated in FIG. 8A, the micro valve 200 was operated under different voltages and input gas pressures. First, each chamber 14, 16 was actuated using both DC and AC (5 MHz) signals and gas flow was monitored through output ports 206. Then, the chambers 14, 16 were operated under different voltages and variable loads between 10 kPa and 50 kPa. The micro valve 200 allowed symmetric high open-flow-capacity of 20.3 sccm at 10 kPa through both outlets (see FIG. 8B). Micro valve 200 could actuate against a maximum pressure of 50 kPa (the pressure source limit) using an AC voltage of 120V, while a much higher DC voltage (>340V) was required for the same operation (see FIG. 8C). DC control shows the hysteresis between closing-action voltage and closed-status-maintaining voltage. Micro valve 200 returns to the full open position when the voltage is applied to the other electrode. When micro valve 200 is closed, the leakage was <10 μL/min. Valve operation under different loading conditions (10-50 kPa), and operation voltages (60-140V, 5 MHz AC) as shown in FIG. 8D. This plot also shows that the use of AC signal (>few MHz) could reduce required voltages by preventing water-dipole movements. Maximum DC voltages are required for ‘closing’ action, while minimum voltages are needed to keep micro valve 200 closed.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A micro actuator comprising:
a first flexible chamber;
a second flexible chamber being fluidly coupled with said first flexible chamber to define a sealed fluid volume;
a dielectric liquid disposed in said sealed fluid volume and flowable between said first flexible chamber and said second flexible chamber; and
a first pair of opposing electrodes coupled with a power source, said first pair of opposing electrodes positioned relative to said first flexible chamber to exert a clamping force on said first flexible chamber in response to an electric potential, said clamping force causing said dielectric liquid to flow into and hydraulically expand said second chamber.

2. The micro actuator according to claim 1, further comprising:
a second pair of opposing electrodes coupled with said power source, said second pair of opposing electrodes positioned relative to said second flexible chamber to exert a clamping force on said second flexible chamber in response to an electric potential, said clamping force causing said dielectric liquid to flow into and hydraulically expand said first chamber.

3. The micro actuator according to claim 2, further comprising:
a third flexible chamber being fluidly coupled with at least one of said first flexible chamber and said second flexible chamber, said third flexible chamber being in fluid communication with said sealed fluid volume;
a third pair of opposing electrodes coupled with said power source, said third pair of opposing electrodes positioned relative to said third flexible chamber to exert a clamping force on said third flexible chamber in response to an electric potential, said clamping force causing said dielectric liquid to flow into and hydraulically expand at least one of said first chamber and said second chamber.

4. The micro actuator according to claim 1 wherein said first flexible chamber and said second flexible chamber comprise at least one differing physical dimension.

5. The micro actuator according to claim 1 wherein said first flexible chamber and said second flexible chamber are identically sized.

6. The micro actuator according to claim 1 wherein a volume of said first flexible chamber is different than a volume of said second flexible chamber.

7. The micro actuator according to claim 1 wherein said clamping force is different than an output force generated in response to said hydraulic expansion of said second chamber.

8. The micro actuator according to claim 1, further comprising:
a liquid channel disposed between said first flexible chamber and said second flexible chamber, said liquid channel defining fluid communication between said first flexible chamber and said second flexible chamber.

9. The micro actuator according to claim 1 wherein said first flexible chamber and said second flexible chamber are integrally formed as a single member.

10. The micro actuator according to claim 1 wherein said dielectric liquid is de-ionized water.

11. The micro actuator according to claim 1 wherein said dielectric liquid is a non-conducting incompressible liquid.

12. The micro actuator according to claim 1, further comprising:
a housing having an inlet and two or more outlets, said housing surrounding said first flexible chamber, said second flexible chamber, said first pair of opposing electrodes, and said dielectric liquid, such that said hydraulic expansion of said second chamber closes at least one of said two or more outlets.

13. A method of manufacturing a micro actuator comprising:
a) patterning a first and a second electrode by evaporating Cr/Au (300/4000 Å);
b) depositing a first continuous polyxylylene polymer layer over said first electrode and said second electrode;
c) patterning a sacrificial photoresist upon said polyxylylene polymer layer;
d) depositing a second continuous polyxylylene polymer layer over said sacrificial photoresist;
e) patterning a third and a fourth electrode on said second continuous polyxylylene polymer layer by evaporating Cr/Au (300/4000 Å), said third and said fourth electrodes being opposingly spaced relative to said first and said second electrodes, respectively;
f) sequentially immersing the assembly from steps a-e into a bath to dissolve said sacrificial photoresist to form an internal chamber filled with liquid, said bath being initially filled with of Acetone, later replaced with IPA, and later replaced with a liquid;
g) sealing said internal chamber while said assembly is disposed in said bath.

14. The method according to claim 13, further comprising:
h) coupling a power source and a control system to each of said first, second, third, and fourth electrodes.

15. The method according to claim 13 wherein said liquid is de-ionized water.

16. The method according to claim 13 wherein said liquid is a dielectric hydraulic liquid.

17. The method according to claim 13 wherein said liquid is a non-conducting incompressible liquid.

18. The method according to claim 13 wherein said sealing said internal chamber while said assembly is disposed in said bath comprises sealing said internal chamber using a UV-curable sealant.
